(19) United States
(12) Patent Application Publication
(10) Pub. No.: US 2009/0189772 A1
(43) Pub. Date: Jul. 30, 2009

(54) STAY-ALERT DEVICE

(76) Inventors: Randolph W. Christ, Brentwood, CA (US); Candi L. Chtist, Brentwood, CA (US); Jonathan Christ, Brentwood, CA (US)

Correspondence Address: West & Associates, A PC, Suite 209, 2815 Mitchell Drive, Walnut Creek, CA, 94598, US

(21) Appl. No.: 12/361,503

(22) Filed: Jan. 28, 2009

Related U.S. Application Data
(60) Provisional application No. 61/024,151, filed on Jan. 28, 2008.

(51) Int. Cl. G08B 23/00

(52) U.S. Cl. 340/575

(57) ABSTRACT

A device for actively engaging a user's body and mind, thus preventing the user from falling asleep and creating a dangerous situation. The device can also alert a user when they begin to doze off.

### STATEMENT OF PRIORITY

The following application claims priority to U.S. Provisional Patent Application No. 61/024,151 filed Jan. 28, 2008, the complete contents of which are hereby incorporated by reference.

### BACKGROUND

1. Field of the Invention

The present disclosure relates to the field of safety devices, specifically a stay-alert system to keep a person alert by active engagement and warning signals.

2. Background

In our modern society, sleep deprivation is an ongoing problem. Whether it is out of necessity (e.g., to earn a living to support one's family) or personal ambition, people feel more pressure to take on inordinate volumes of work and accomplish more each day than ever before. Thus, there is little time for sleep, which is necessary to rejuvenate the mind and body. This poses safety and efficiency problems, especially for people who operate motor vehicles or heavy machinery. Thousands of injuries and deaths occur each year due to drivers dozing off behind the wheel, and the monetary losses resulting from such accidents is in the millions of dollars.

When sleep deprivation is combined with monotonous, boring or routine activities, one can easily fall asleep no matter how much effort is used to counteract the fatigue. Several products are currently on the market with the goal of keeping people alert, especially in situations where the safety of others is at risk. One such product is a supplement called NoDoz®, which is essentially large amounts of caffeine in pill form. Several similar supplements exist in both pill and liquid form, such as the drink Red Bull®. However, while some people may respond well to stimulants, others either prefer not to take them or do not respond well or at all to them.

As an alternative, many devices have been produced to provide an alarming signal when a user falls asleep. One such device is Smart Alert, (www.smartalert.co.za/index/html, last visited Jan. 23, 2009), an over-the-ear device that operates by detecting when a user's head falls below a certain predetermined angle, and then sounding an alarm in the user's ear. This type of device has many flaws, however, such as limiting a user to a certain head position (thus having the potential of generating false positive alarms) and not providing constant and active engagement. Thus, while an alarm may sound when one is dozing off, there is no mechanism to prevent the user from dozing off again.

Some devices monitor a person's eyelash movements in order to determine when eyes are closed for too long, but they still only sound an alarm and do not provide active engagement. Other devices on the market are quite complex and costly, requiring several sensors, processors, controllers, cameras, alarm mechanisms and so forth. These devices can also require complex calibration and installation.

What is needed is a simple, inexpensive, self-calibrating, stay-alert system and device that actively engages a user, thereby preventing them from falling asleep. The device should also warn a user when they start to doze off, rather than when they have already fallen asleep. The device set forth in the present disclosure satisfies these needs.

### BRIEF DESCRIPTION OF THE DRAWINGS

FIG. 1 depicts one embodiment of an active engagement device.

FIG. 2 depicts the embodiment of FIG. 1 in use.

FIG. 3 depicts an alternate embodiment of an active engagement device.

FIG. 4 depicts a glove embodiment of an active engagement device.

FIG. 5 depicts a steering wheel cover embodiment of an active engagement device.

FIG. 6 depicts examples of output modules and their locations in a motor vehicle.

FIG. 7 depicts another example of an output module, specifically hazard lights on the back of a truck.

FIG. 8 depicts a flowchart of the operation of the current device.

FIG. 9 depicts a circuit associated with one embodiment of the current device.

### DETAILED DESCRIPTION

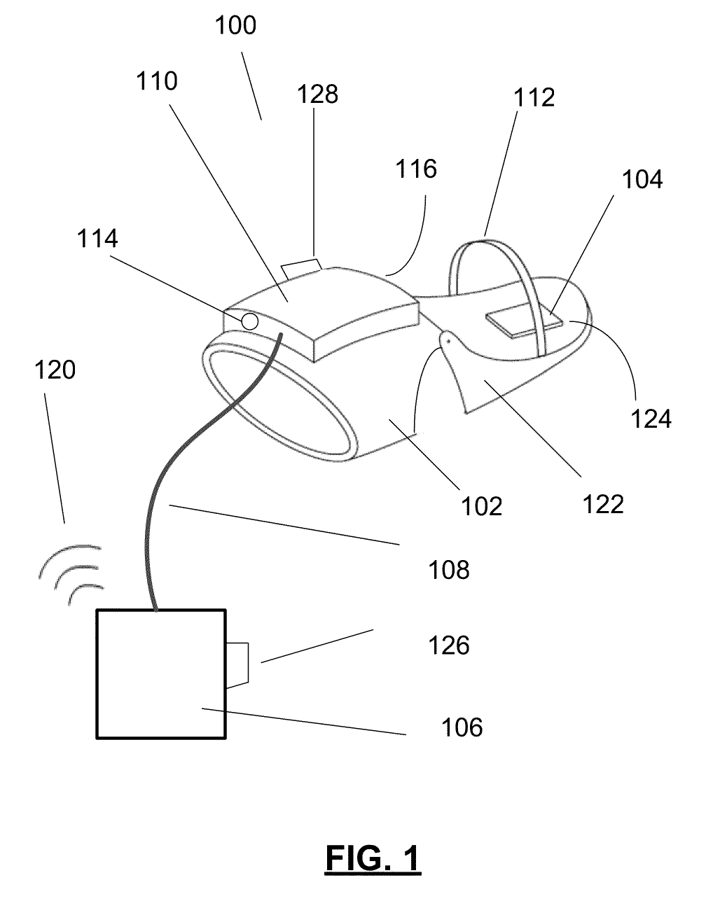

An active engagement device 100 is depicted in FIG. 1. A support structure 102 can be coupled with at least one sensor 104. A sensor 104 can detect a predetermined user input and translate the user input to an output module 106 via a signal transmission mechanism 108. An output module 106 can subsequently produce a preprogrammed signal 120 that can be perceived by the user.

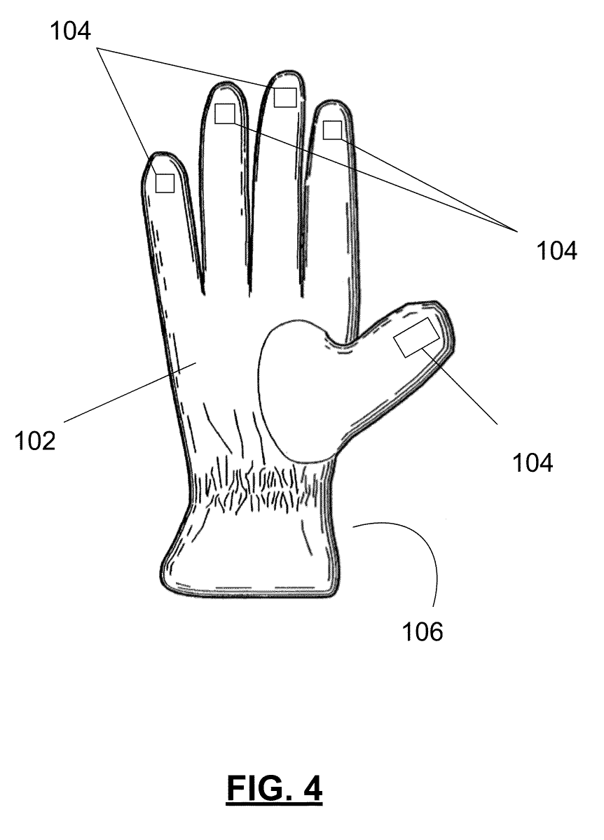

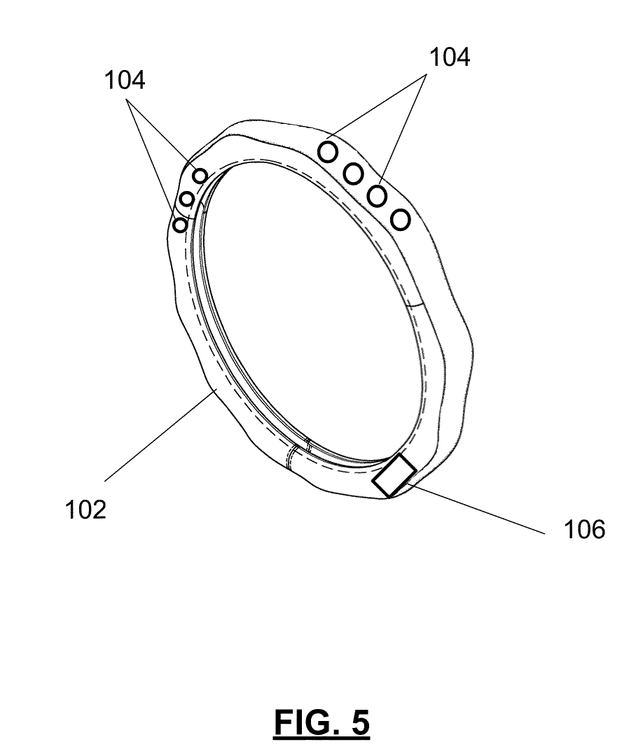

FIGS. 1-3 depict a support structure 102 as having tubular geometry that can be adapted to fit over a person's finger. Specifically, as shown in FIG. 1, this tubular embodiment can have a hinged portion 122 to allow bending of a user's finger. As depicted in FIG. 4, in an alternate embodiment a support structure 102 can be substantially glove-shaped, and can be adapted to fit over a person's hand. In yet another embodiment, a support structure 102 can be a cover adapted to fit over the steering wheel of a motor vehicle, as shown in FIG. 5. In other embodiments, a support structure 102 can have any other known and/or convenient geometry.

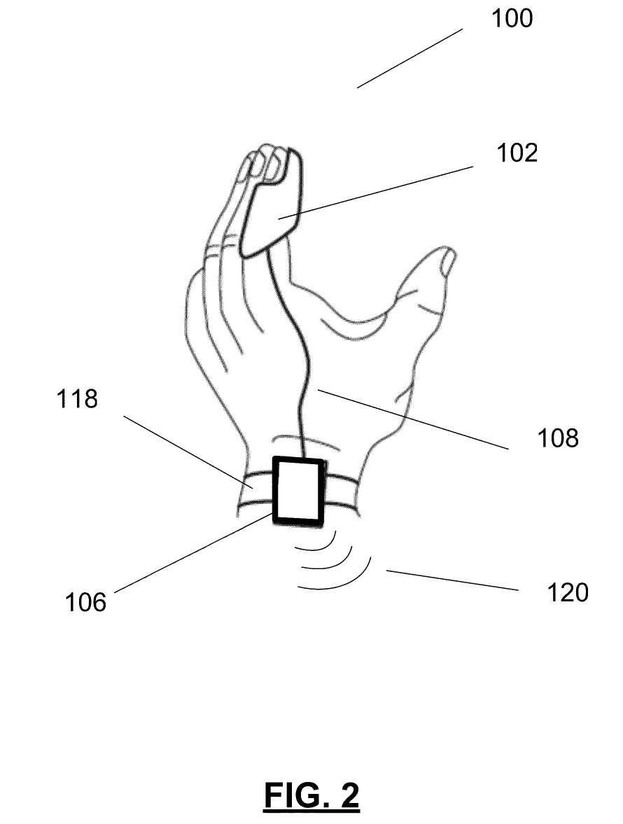

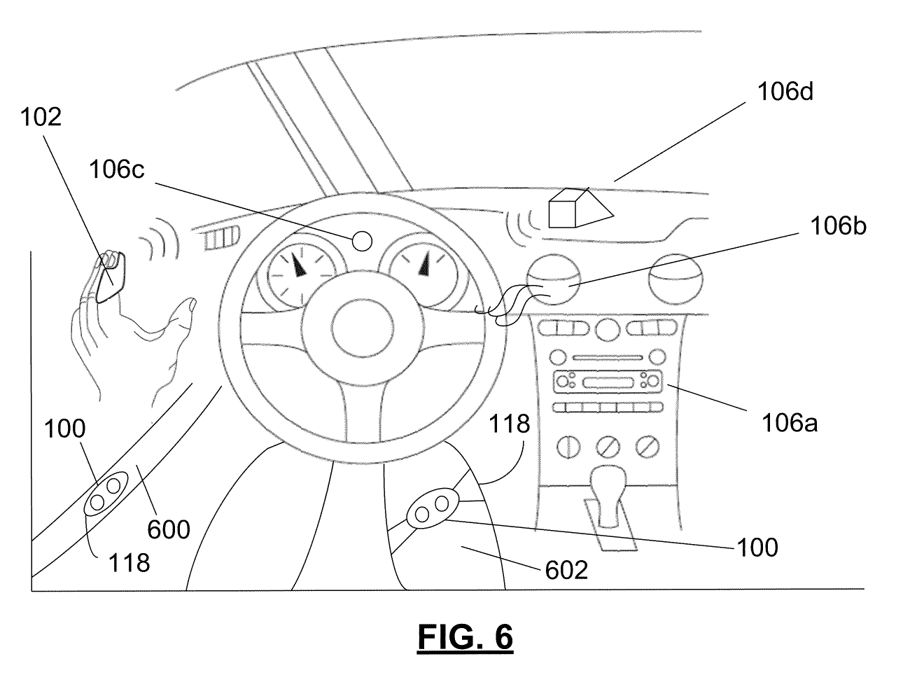

A support structure 102 can be coupled with a housing unit 110 that can house a variety of desired components, as shown in FIG. 1. A housing unit 110 can house a signal transmission mechanism 108, an output module 106, a power source 116, and/or any other known and/or convenient or desired component. A support structure 102 can also be coupled with a headset jack 114. As shown in FIG. 1, a support structure 102 can have a finger strap 112 that can ensure proper positioning of a user's finger. A finger strap can be plastic, fabric, elastomer, or any other known and/or convenient material, and can secure a finger by snaps, hooks and loops, or by any other known and/or convenient fastening means. In other embodiments, and as explained in further detail below, an active engagement device 100 can further comprise fastening means 118 that can hold device components in place on either a user or an object, such as the output module 106 depicted in FIG. 2. FIG. 6 depicts additional non-limiting examples of fastening means 118 in use. An active engagement device 100 can be secured to a user's leg 602 via fastening means 118. In another embodiment, an active engagement device 100 can be secured to a vehicle armrest 600 via fastening means 118.

A support structure 102 can be rigid material, as shown in FIG. 1. In alternate embodiments, a support structure 102 can be semi-rigid or, as shown in FIGS. 4-5, can be made of flexible material. A support structure 102 can be made of plastic, rubber, polymer, fabric, neoprene, or any other known and/or convenient material or combination of materials. The surface of a support structure 102 can be smooth or can have ridges, indentations, apertures, or any other known and/or convenient surface characteristics. In the case of a support structure 102 that is intended to be worn against human skin, a support structure 102 can be moisture-wicking, insulating, or can have any other known and/or convenient properties.

A support structure 102 can be coupled with at least one sensor 104. A sensor 104 can be partially embedded in a support structure 102, as depicted in FIG. 1. In alternate embodiments, a sensor 104 can be completely embedded into, integral with, or attached to the interior or exterior surface of a support structure 102, or can be coupled with a support structure 102 in any other known and/or convenient manner.

A sensor 104 can detect a predetermined form of user input by digital, optical, pressure, thermal, humidity, or infrared mechanisms, or by any other known and/or convenient sensor mechanisms. As shown in FIG. 1, a sensor 104 can be a push button. In other embodiments, a sensor can be a switch or any other known and/or convenient mechanical and/or electromechanical element. In alternate embodiments, a sensor 104 can operate by electronic and/or mechanical means only.

In the embodiment shown in FIGS. 1-3, a sensor 104 comprises a microprocessor 124 that can detect the time elapsed between user inputs and send a signal to an output module 106 upon the occurrence of a predetermined condition. A predetermined condition can be the passage of a certain amount of time, detection of pressure or temperature change, or any other know and/or convenient condition. Thus, if a user presses a button sensor 104 and does not press it again after a certain amount of time, the microprocessor 124 can subsequently activate an output module 106 such that a signal 120 is produced and perceived by the user, alerting them of their failure to press the sensor 104 within the allotted time frame.

In alternate embodiments, an active engagement device 100 can comprise a plurality of sensors 104, each of which can trigger a different perceivable signal 120 from an output module 106. For instance, a series of sensors 104 can act as a musical instrument, allowing a user to play songs. An output module 106 can prompt a user by playing a certain melodic sequence. The user can then be required to repeat that same melodic sequence by input via the sensors 104 and, in the event of failure to do so, a microprocessor 124 can activate an output module 106, thereby producing a perceivable signal 120 and alerting the user. In other embodiments, a microprocessor 124 can use any other known and/or convenient parameters or conditions in order to communicate with an output module 106 at an appropriate, desired time.

A sensor 104 can operate by detecting the amount of pressure a user exerts on a specified area of the sensor 104. In one embodiment, a sensor 104 may have a threshold value for a predetermined level of force that a user is required to constantly exert on the sensor 104. If the amount of force exerted falls below the threshold value, the sensor 104 can communicate with an output module 106 via a signal transmission mechanism 108 in order to produce a signal 120 and alert the user that they are not meeting the required threshold. For example, if a user is continuously pressing down on a button sensor 104, when they start to fall asleep the force exerted will generally decrease slowly over a period of time. A sensor 104 can be programmed to detect this slow change in pressure, interpret it as the user falling asleep, and subsequently communicate with an output module 106 to emit a signal 120 to the user.

In alternate embodiments, a sensor 104 can simply detect user contact with a specified area of the sensor 104 without requiring the user to exert much force. For example, a thermal sensor can determine lack of contact with a user by detecting temperature changes. In alternate embodiments, a user can engage a sensor 104 by simple light tapping on a specified area. In other embodiments, a sensor 104 can detect user input via any other known and/or convenient method or means.

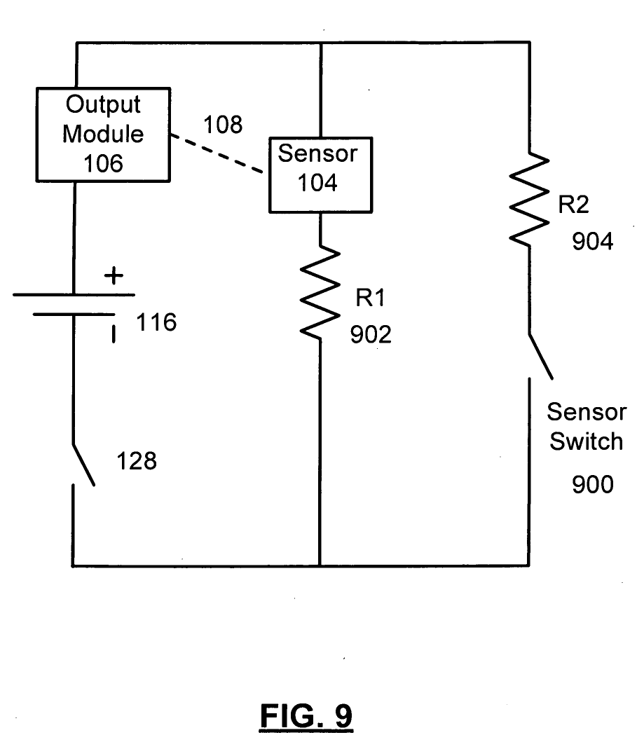

A sensor 104 can be operatively coupled with an output module 106 via a signal transmission mechanism 108. As shown in FIG. 9, a power switch 128 can be coupled in series with a power source 116 and an output module 106. These components can be further coupled in parallel with a series-coupled sensor 104 and a first resistor 902, and a series-coupled second resistor 904 and sensor switch 900. When the power switch 128 is in an open position, the entire circuit can be uncharged. When the power switch 128 is in a closed position and the sensor switch is open, a first voltage can be detected by the sensor 104. When both the power switch 128 and sensor switch are closed, a second voltage can be detected by the sensor, which then sends a signal to the output module 106 via a signal transmission mechanism 108. The output module 106 can then emits a signal 120 to alert the user.

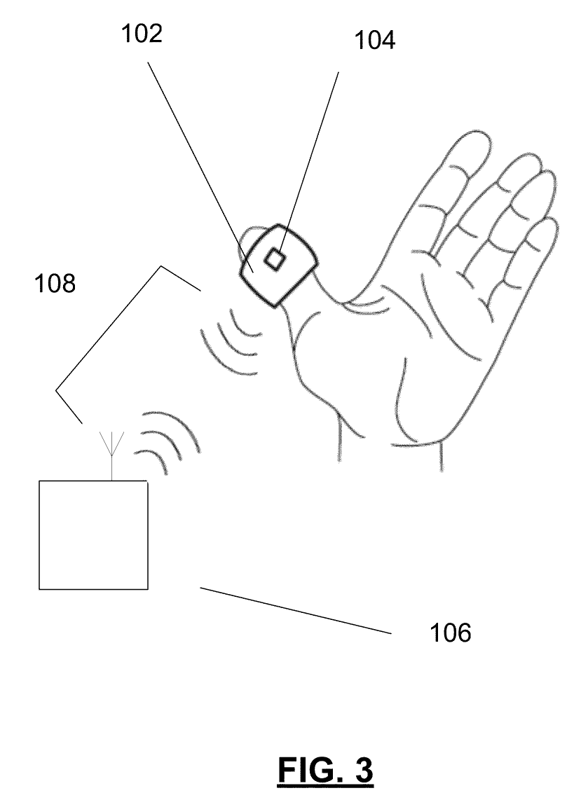

As shown in FIGS. 1-2, a signal transmission mechanism 108 can operate via a simple wired connection. In such embodiments, a signal transmission mechanism 108 can be exposed and visible to the user. In other embodiments, a signal transmission mechanism 108 can be covered or otherwise not visible to the user, such as when both an output module 106 and signal transmission mechanism 108 are housed within a housing unit 110. As shown in FIG. 3, in alternate embodiments a signal transmission mechanism 108 can transmit wireless signals to and from a sensor 104. A signal transmission mechanism 108 can produce wireless signals via radio, microwave, or infrared frequencies, or any other known and/or convenient frequency. A signal transmission mechanism 108 can also utilize Bluetooth® or Wi-Fi® technologies, thus enabling the communication between a sensor 104 and any Bluetooth® or Wi-Fi® compatible device, such as cellular telephones, headsets, computers, Bluetooth®-enabled vehicle components, or any other known and/or convenient compatible device.

In some embodiments, a sensor 104 can communicate with a vehicle component other than an output module 106, via a second signal transmission mechanism 108, in order to turn off the motor or lock the gas pedal, thereby causing deceleration of the vehicle, when a user starts to fall asleep. In other embodiments, an output module 106 can emit both perceivable signals 120 to a user as well as non-perceivable signals instructing a vehicle to shut off its motor or lock the gas pedal, thus eliminating the need for a second signal transmission mechanism 108.

An output module 106 can receive signals from at least one sensor 104 via a signal transmission mechanism 108, and can subsequently produce a perceivable signal 120 that can alert a user of loss of engagement with the device 100. An output module 106 can be in constant contact with a user's body or extremities, or can have little or no contact with a user during operation. As depicted in FIGS. 4-5, an output module 106 can be integrated with a support structure 102. When integrated with a support structure 102, an output module 106 can be housed within a housing unit 110 and can be either visible or concealed.

In other embodiments, an output module 106 can be a freestanding component, as shown in FIGS. 1-3. A freestanding output module 106 can communicate with a sensor 104 wirelessly or by a wired connection; in either configuration, an output module 106 can have a fastening means 118 to ensure that the output module 106 is secure in a desired and/or appropriate place on a users body, as shown in FIG. 2. In alternative embodiments where an output module 106 is separate from a support structure 102, an output module 106 can have fastening means 118 such as a suction device, reusable adhesive, or any other known and/or convenient means for securing the output module 106 in a desired location and/or position on or off of a user's body. By way of non-limiting example, FIG. 6 depicts an on-dash output module 106d, which can be secured to the dashboard of a motor vehicle either permanently or by fastening means 118 as described above.

Rather than being a freestanding device, an output module 106 can be an already-existing component owned by a user and/or integrated with a motor vehicle. As shown in FIG. 6, an output module 106 can be a vehicle's music system 106a, a vehicle climate control system 106b, or a built-in light source 106c. In an embodiment wherein an output module 106 is a vehicle's music system 106a, a signal transmission mechanism 108 can activate the music system or, if already activated, increase its volume in order to alert the user of inattentiveness. In an embodiment wherein an output module 106 is a vehicle's climate control system 106b, a signal transmission mechanism 108 can activate the air conditioning unit or increase its output, thereby awakening the user by a blast of cold air. In an embodiment wherein an output module 106 is a built-in light source 106c, a signal transmission mechanism 108 can activate the light source and cause it to flash on and off in order to catch the attention of the user.

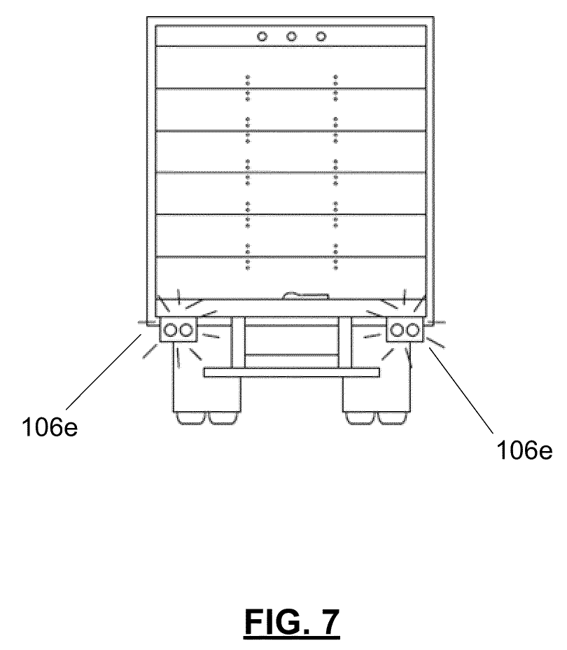

In alternate embodiments, as shown in FIG. 7, an output module 106 can be the rear hazard lights 106e of a motor vehicle, thereby alerting other drivers or pedestrians that their safety may be at risk. Activation of rear hazard lights 106e can be in addition to any in-vehicle alert to the user. In other embodiments, an output module 106 can be any other known and/or convenient device that is integral with a motor vehicle. An output module 106 can also be a component that can control multiple devices within a motor vehicle, such as a light source, music system, or climate control system.

An output module 106 can emit various types of perceivable signals 120 to alert a user when they are falling asleep or are otherwise inattentive. A signal 120 can be audible, such as an alarm, music, or pre-recorded sounds, or can be musical notes that a user controls by different inputs into at least one sensor 104. A signal 120 can also be visual, such as light emitted from an LED or other type of light source. If an output module 106 is in close contact with a user, a signal 120 can be a vibration or minor electrical shock. A signal 120 can be any type of movement that can alert and/or awaken a user, such as a moving seat bottom or headrest. In other embodiments, a signal 120 emitted from an output module 106 can be any other known and/or convenient signal perceivable by the user.

An output module 106 can also have at least one adjustment mechanism 126, as depicted in FIG. 1. An adjustment mechanism 126 can be a button, switch, or any other known and/or convenient mechanism by which a user can control the settings of an output module 106. An adjustment mechanism 126 can be integral with an output module 106, coupled with a support structure 102, or located at any other known and/or convenient position on a device 100.

An adjustment mechanism 126 can be used to adjust the type, intensity, and/or frequency of a signal 120 emitted from an output module 106. For example, an adjustment mechanism 126 can be used to choose the type of signal 120 or combination of signals 120, such as switching from a vibration mode to an audible mode. In other embodiments, an adjustment mechanism 126 can control the volume of an audible signal 120. In yet other embodiments, an adjustment mechanism 126 can allow a user to change the type of music that can be emitted from an output module 106, similar to changing ringtones on modern cell phones. In alternate embodiments, an adjustment mechanism 126 can allow a user to control any other known and/or convenient property of an output module 106.

An output module 106 and/or sensor 104 can be programmed to suspend operation upon detection of an incoming cell phone call, since conversing on a cell phone is generally sufficient stimulation to keep a user awake and alert. Additionally, an active engagement device 100 can be programmed to repeatedly ask a user if they desire to use the device. For instance, if an active engagement device 100 is not turned on for use by 10:00 pm when a user is driving, it can automatically power on and ask the user to commence active engagement.

An active engagement device 100 can have its own power source 116, as shown in FIG. 1. The power source 116 can be located within a housing unit 110 or otherwise coupled with a support structure 102. In other embodiments, a power source 116 can be integral with an output module 106. In alternate embodiments, a power source 116 can be located at any other known and/or convenient location on a device 100. A power source 116 can be a disposable or rechargeable battery, or can be any other known and/or convenient source of energy.

An active engagement device 100 can also draw power from an external source. An external power source 116 can be the battery of a motor vehicle, similar to the method by which a cellular telephone draws power from a vehicle to charge its battery. However, in some embodiments, an active engagement device 100 can be devoid of any type of battery and can run solely on the energy drawn from an external power source 116. In other embodiments, a power source 116 can be the sun, whereby solar film can be coupled with the active engagement device 100 to absorb energy and power the device 100. In alternate embodiments, a power source 116 can be any other known and/or convenient device, mechanism, or method for providing power to a device 100. A power source 116 can be activated or deactivated by the user via a power switch 128 that can be positioned at any known and/or convenient location on the device 100. A power switch 128 can be a button, slide switch, or any other known and/or convenient mechanism for activating and deactivating the power source 116.

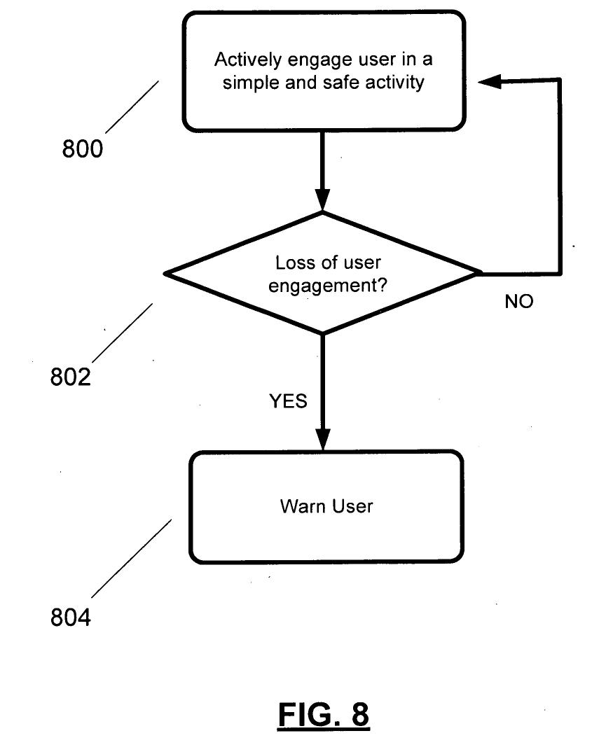

FIG. 8 depicts the process by which an active engagement device 100 can alert a user of drowsiness, inattention, or any other predetermined condition. At step 800, a user actively engages a sensor 104 with a finger, thumb, or palm, or performs any other known and/or convenient safe and simple activity. This simply activity can keep the user's mind stimulated and alert, thus preventing the user from falling asleep. At step 802, a sensor 104 can check to see if there is any loss of user engagement. Step 802 can occur at any known and/or convenient predetermined time interval or other condition. If there has been no loss of user engagement or if the loss of engagement does not meet a required threshold, a sensor 104 can refrain from communicating with an output module 106 via a signal transmission mechanism 108, thus allowing the user to continue active engagement without emission of a perceivable signal 120. Should loss of user engagement be detected, the system can proceed to step 804 and warn the user.

As shown in FIG. 1, a support structure 102 can be a tubular member adapted to fit over a user's finger. In use, a user can slide the support structure 102 over an index finger (as shown in FIG. 2) such that the pad of the finger is in contact with a sensor 104. A finger strap 112 can be used to hold the user's finger in place. As shown in FIG. 2, a user can then secure an output module 106 to the wrist of the same hand on which the support structure 102 is worn. When the user is ready to turn on the device 100, a power switch 128 is used to activate a power source 116. The user must then press down on a sensor 104 at regular, predetermined intervals in order to let the system know that there is active engagement. If the user fails to press down on the sensor 104 at a scheduled time, because the user is drowsy or otherwise inattentive, the sensor 104 sends an electronic signal to the output module 106 via the wired signal transmission mechanism 108. The output module 106 subsequently emits a perceivable signal 120 so that the user is alerted to their failure to continue active engagement with the device 100.

Another embodiment is depicted in FIG. 3. In use, a user can place a support structure 102 over a thumb. The sensor 104 is positioned on the exterior of the support structure 102, thus the user can actively engage the sensor 104 by bringing any other finger or other surface into contact with it. In this embodiment, an output module 106 communicates with a sensor 104 via a wireless signal transmission mechanism 108.

An alternate embodiment is shown in FIG. 4. A support structure 102 is a glove member adapted to fit over the user's entire hand. Each finger of the glove has a sensor 104 located near the finger pad area. A user then actively engages each sensor 104 by pressing each finger against a sufficiently rigid object. The user can engage each sensor 104 at separate times, or can engage the sensors 104 all at the same time.

FIG. 5 depicts yet another embodiment of the device 100. A support structure 102 is a section of material adapted to fit over a user's vehicle steering wheel. Several sensors 104 are coupled with the support structure 102 such that a user can easily and conveniently apply force or otherwise engage the sensors 104. In this embodiment, a user can safely grip the steering wheel of a vehicle with both hands while simultaneously using the active engagement device 100, thereby enhancing the safety of the user, passengers in the same vehicle, other drivers or pedestrians.

Although the invention has been described in conjunction with specific embodiments thereof, it is evident that many alternatives, modifications and variations will be apparent to those skilled in the art. Accordingly, the invention as described and hereinafter claimed is intended to embrace all such alternatives, modifications and variations that fall within the spirit and broad scope of the appended claims.

What is claimed is:

1. A device comprising:
a support structure;
a sensor coupled with said support structure, wherein said sensor is adapted to detect a predetermined user input;
an output module;
a signal transmission mechanism coupled with said sensor and said signal output module; and
said sensor further comprising a microprocessor that triggers said signal transmission mechanism when said predetermined user input is not detected within a predetermined amount of time.

2. The device of claim 1, wherein said microprocessor comprises a timer mechanism.

3. The device of claim 1, further comprising a fastening mechanism coupled with said support structure.

4. The device of claim 1, further comprising a fastening mechanism coupled with said output module.

5. The device of claim 1, wherein said output module further comprises an adjustment mechanism.

6. The device of claim 1, further comprising a housing unit coupled with said support structure.

7. The device of claim 1, further comprising a power source.

8. The device of claim 1, further comprising a headset jack coupled with said support structure.

9. The device of claim 1, wherein said output module produces a signal selected from the group consisting of: sound, vibration, movement, light, and thermal.

10. The device of claim 7, further comprising a power switch coupled with said power source.

11. The device of claim 1, wherein said signal transmission mechanism is adapted to transmit wireless signals between said sensor and said output module.

12. The device of claim 1, wherein said signal transmission mechanism is a wired connection between said sensor and said output module.

13. The device of claim 1, wherein said sensor is integral with said support structure.

14. The device of claim 11, further comprising an antenna coupled with said output module, wherein said antenna is adapted to emit and receive wireless signals.

15. The device of claim 1, wherein said support structure is selected from the group consisting of: tubular member, glove, planar member, and steering wheel cover.

16. The device of claim 1, wherein said output module is selected from the group consisting of: vehicle music system, in-dash light source, climate control unit, vehicle hazard lights, headset, and cellular telephone.
